(19) United States
(12) Patent Application Publication
(10) Pub. No.: US 2025/0046092 A1
(43) Pub. Date: Feb. 6, 2025

(54) ASSISTANCE CONTROL DEVICE, ASSISTANCE CONTROL METHOD, AND COMPUTER-READABLE STORAGE MEDIUM

(71) Applicant: HONDA MOTOR CO.,LTD., Tokyo (JP)

(72) Inventors: Takahiro KUREHASHI, Saitama (JP); Moriya HORIUCHI, Saitama (JP); Yuta SAKAGAWA, Saitama (JP)

(21) Appl. No.: 18/767,942

(22) Filed: Jul. 9, 2024

(30) Foreign Application Priority Data
Jul. 31, 2023 (JP) 2023-124434

(51) Int. Cl. G06V 20/54; G06T 7/246; G06T 7/73

(52) U.S. Cl. CPC G06V 20/54; G06T 7/248; G06T 7/73; G06T 2207/30236

(57) ABSTRACT

An assistance control device includes: a recognition processing module which performs a recognition process by comparing position information of a first movable body detected from an image captured by a capturing device to position information of a second movable body measured at each of the second movable body for each combination of the first movable body and the second movable body and recognizing, as a single movable body, a combination of movable bodies having a degree of coincidence of position information which is higher than a predetermined value; and an assistance control module which performs control for traffic assistance for a movable body based on position information of a movable body obtained by applying the recognition process to the position information of the first movable body and the position information of the second movable body.

The contents of the following patent application(s) are incorporated herein by reference: NO. 2023-124434 filed in JP on Jul. 31, 2023.

### BACKGROUND

### 1. Technical Field

The present invention relates to an assistance control device, an assistance control method, and a computer-readable storage medium.

### 2. Related Art

In recent years, efforts have been intensified to provide access to a sustainable transportation system with consideration given to even vulnerable people among other traffic participants. To realize this, research and development has been focused on to further improve traffic safety and convenience through research and development regarding a preventive safety technique. Patent Document 1-6 describes a technique related to assisted driving of a vehicle.

### PRIOR ART DOCUMENT

### Patent Document

Patent Document 1: Japanese Patent Application Publication No. 2019-175201
Patent Document 2: Japanese Patent Application Publication No. 2021-92840
Patent Document 3: Japanese Patent Application Publication No. 2019-78554
Patent Document 4: WO2020/165981
Patent Document 5: WO2019/188429
Patent Document 6: Japanese Patent Application Publication No. 2021-167770

### BRIEF DESCRIPTION OF THE DRAWINGS

FIG. 1 schematically shows a usage scenario of an assistance system 10.

FIG. 2 shows a functional arrangement of an assistance device 60.

FIG. 3 shows, in a tabulated form, the first reception information which the assistance device 60 receives from the capturing device 70.

FIG. 4 shows, in a tabulated form, the second reception information which the assistance device 60 receives from a user terminal 82.

FIG. 5 is a diagram for describing a recognition process in a recognition processing module 240.

FIG. 6 is another diagram for describing the recognition process in the recognition processing module 240.

FIG. 7 schematically shows another example of the range to which the recognition process is to be applied.

FIG. 8 is a diagram for describing the assistance method in a case where a user 80f goes out of the capturing range of the capturing device 70.

FIG. 9 shows an example of the flowchart related to the assistance control method performed by the assistance device 60.

FIG. 10 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solving means of the invention.

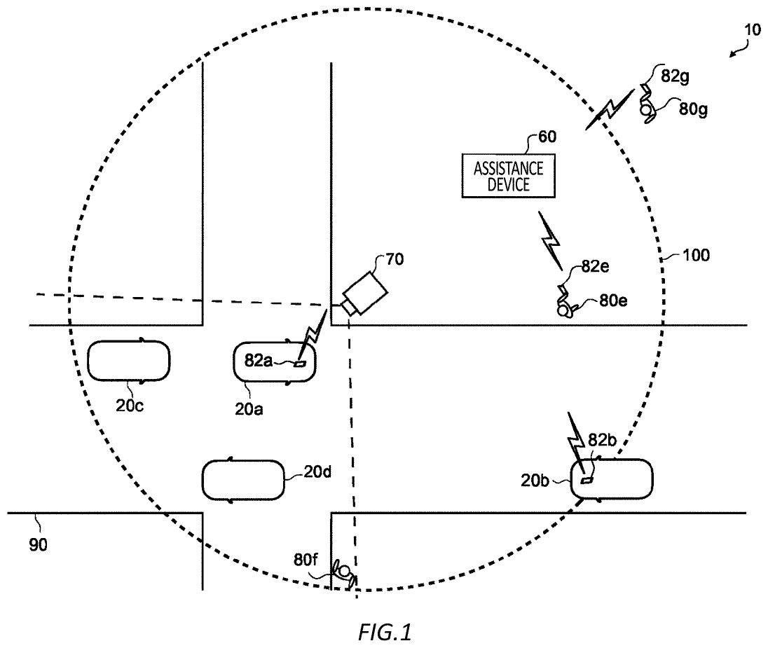

FIG. 1 schematically shows a usage scenario of the assistance system 10. The assistance system 10 includes a vehicle 20a, a vehicle 20b, a vehicle 20c, a vehicle 20d, a capturing device 70, an assistance device 60, a user terminal 82a, a user terminal 82b, a user terminal 82e, and a user terminal 82g.

In the present embodiment, the vehicle 20a, the vehicle 20b, the vehicle 20c, and the vehicle 20d are sometimes collectively referred to as “vehicle 20”. The user terminal 82a, the user terminal 82b, the user terminal 82e, and the user terminal 82g are sometimes collectively referred to as “user terminal 82”. The user 80e, the user 80f, and the user 80g are sometimes collectively referred to as “user 80”.

In the present embodiment, the vehicle 20 is a vehicle traveling along the road 90. The vehicle 20 is an example of a mobile body.

The user terminal 82a and the user terminal 82b are the terminals which the occupants of the vehicle 20a and the vehicle 20b possess, respectively. The user terminal 82e is a terminal which the user 80e possesses. The user terminal 82g is a terminal which the user 80g possesses. The user 80f does not possess a user terminal. In the present embodiment, the user 80e, the user 80f, and the user 80g are pedestrians.

The user terminal 82 is a mobile terminal such as a smartphone, for example. The user terminal 82 is an example of the mobile body. The user terminal 82 periodically transmits to the assistance device 60 the current position information of the user terminal 82 detected by a position sensor including a GNSS receiver. For example, the user terminal 82 transmits to the assistance device 60 latitude and longitude information representing the current position of the user terminal 82.

The capturing device 70 is a capturing device provided on traffic infrastructure. The capturing device 70 obtains the positions of the vehicle 20 and the user 80 existing within the capturing range of the capturing device 70 by analyzing the captured image and transmits to the assistance device 60 the obtained position of the vehicle 20 and the user 80.

The vehicle 20 and the user 80 are traffic participants. The vehicle 20 and the user 80 are examples of the movable bodies to which assistance may be applied by the assistance device 60.

The assistance device 60 receives via mobile communication the position information transmitted from the user terminal 82. The assistance device 60 may receive, through any combination of the mobile communication and the communication line such as the Internet and a dedicated line, the information which is transmitted from the user terminal 82 and the capturing device 70.

In the situation shown in FIG. 1, the vehicle 20a, the vehicle 20c, the vehicle 20d, and the user 80f are located within the capturing range of the capturing device 70. The capturing device 70 identifies each position of the vehicle 20a, the vehicle 20c, the vehicle 20d, and the user 80f by analyzing the image obtained through capturing and transmits to the assistance device 60 the position information indicating the identified position.

The assistance device 60 selects the movable body to which the assistance is to be applied among the vehicle 20 and the user 80 based on each position information of the user terminal 82 received from the user terminal 82 and the position information of the vehicle 20a, the vehicle 20c, the vehicle 20d, and the user 80f received from the capturing device 70, and performs assistance for the selected movable body.

As an example, the assistance device 60 determines that the vehicle 20a and the user 80e will approach each other within a predetermined time based on the history of the position information of the vehicle 20a obtained by the capturing device 70 and the history of the position information of the user 80e detected by the user terminal 82e. In this case, the assistance device 60 performs assistance for the user 80e by transmitting to the user terminal 82e the assistance information instructing to output an alarm.

Here, the assistance device 60 does not only receive the position information of the user terminal 82a from the user terminal 82a which the occupant of the vehicle 20a possesses but also receives the position information of the vehicle 20a obtained by the capturing device 70 analyzing the image. The user terminal 82a moves together with vehicle 20a. Therefore, it is not preferable to perform processing related to assistance assuming that there is a movable body at each of the position detected by the user terminal 82a and the position of the vehicle 20a obtained by the capturing device 70. Rather, it is desirable that the user terminal 82a and the vehicle 20a are recognized as a single movable body.

Therefore, the assistance device 60 compares the position information of the user terminal 82a detected by the user terminal 82a to the position information of the vehicle 20a obtained by the capturing device 70 and, according to the result of comparison, performs the recognition process by recognizing the user terminal 82a and the vehicle 20a as a single movable body. The assistance device 60 performs assistance for the traffic participants based on the position information which has been aggregated as a result of the application of the recognition process.

When performing the recognition process, the assistance device 60 does not perform the comparison for all the combinations of the position information obtained by the capturing device 70 and the position information detected by the user terminal 82 but limits, to the position information within the range 100, the position information to which the comparison is applied. In one embodiment, the range 100 is set to be the predetermined range including the position at which the capturing device 70 is installed. In one embodiment, the range 100 may be the range where the distance from the position at which the capturing device 70 is installed is equal to or less than a predetermined set value. The set value may be 300 m, for example.

According to the assistance system 10, the position information to which the recognition process is to be applied can be limited. As a result, the processing load in the assistance device 60 can be reduced.

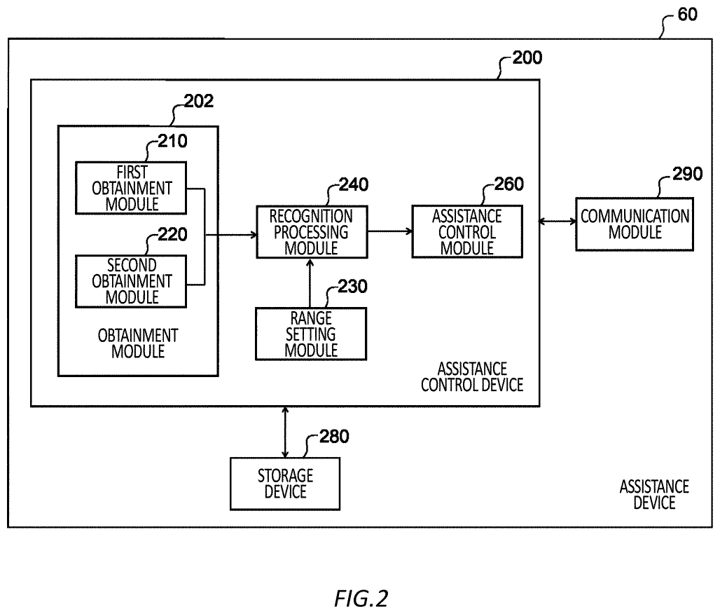

FIG. 2 shows the functional arrangement of the assistance device 60. The assistance device 60 includes an assistance control device 200, a communication device 290, and a storage device 280.

The communication device 290 is responsible for the communication between each of the user terminal 82 and the capturing device 70 and the assistance device 60 based on the control from the assistance control device 200. The assistance control device 200 is implemented by including a circuit such as an arithmetic processing device including a processor, for example. The assistance control device 200 may be implemented by a microcomputer including a CPU, a ROM, a RAM, I/O, a bus or the like. The storage device 280 is implemented by being provided with a non-volatile storage medium. The assistance control device 200 performs a process using the information stored in the storage device 280. The storage device 280 stores map information including the information indicating the position of the road 90.

The assistance control device 200 includes an obtainment module 202, an assistance control module 260, a recognition processing module 240, and a range setting module 230. The obtainment module 202 includes a first obtainment module 210 and a second obtainment module 220. An embodiment may be employed in which the assistance device 60 does not have some functions among the functional arrangement shown in FIG. 2.

The first obtainment module 210 obtains the position information of the first movable body detected from the image captured by the capturing device 70. The first obtainment module 210 obtains the position information of the first movable body from the position information transmitted from the capturing device 70.

The second obtainment module 220 obtains the position information of the second movable bodies measured at each the second movable bodies. The second movable body in the present embodiment is the user terminal 82. The second obtainment module 220 obtains the position information of the user terminal 82 from the position information transmitted from the user terminal 82.

In the present embodiment, the first obtainment module 210 obtains the position information of the first movable body detected from the image captured by the capturing device 70 and the second obtainment module 220 obtains the position information of the user terminal 82 measured at each of the user terminals 82. However, in the embodiment where the vehicle 20 includes a capturing device which captures images of the surroundings of vehicle 20, the first obtainment module 210 may obtain the position information of the first movable body detected from the image captured by the capturing device included in the vehicle 20. When the vehicle 20 includes a position sensor including a GNSS receiver, the second obtainment module 220 may obtain the position information of the vehicle 20 measured by the position sensor provided on the vehicle 20.

The recognition processing module 240 performs the recognition process by comparing the position information of the first movable body to the position information of the second movable bodies for each combination of the first movable body and the second movable bodies and recognizing, as a single movable body, the combination of the movable bodies having a degree of coincidence of the position information which is higher than a predetermined value. In doing this, the recognition processing module 240 limits the position information to which the recognition process is to be applied among the position information of the first movable body and the position information of the second movable bodies to the position information within a predetermined range which is set with the position of the capturing device 70 as the reference. The assistance control module 260 performs control for traffic assistance for the movable bodies based on the position information of the movable bodies obtained by applying the recognition process to the position information of the first movable body and the position information of the second movable bodies.

The predetermined range may be a fixed and predetermined range 100 including the installation position of the capturing device 70. The range setting module 230 may select, among the position information of the first movable body obtained by the first obtainment module 210, at least four pieces of position information having the outermost coordinate component for each of the two coordinate axes determined within a predetermined range, and set the range defined by the line passing through each of the select position information as the predetermined range.

As an example, the recognition processing module 240 compares the position indicated by the position information of the first movable body to the position indicated by the position information of the second movable bodies for each combination of the first movable body and the second movable bodies and recognizes, as a single movable body, a combination of movable bodies having a degree of coincidence of positions which is higher than a predetermined value. The recognition processing module 240 may recognize, as a single movable body, a combination of movable bodies having the degree of coincidence of positions which is higher than a predetermined value for a predetermined time.

The recognition processing module 240 may further compare the moving direction identified from the history of the position information of the first movable body to the moving direction identified from the history of the position information of the second movable bodies for each combination of the first movable body and the second movable bodies and recognize, as a single movable body, a combination of movable bodies having a degree of coincidence of positions which is higher than a predetermined value and a degree of coincidence of moving directions which is higher than a predetermined value. The recognition processing module 240 may recognize, as a single movable body, a combination of movable bodies having a degree of coincidence of positions which is higher than a predetermined value for a predetermined time and a degree of coincidence of moving directions which is higher than a predetermined value for a predetermined time.

The recognition processing module 240 may perform a first evaluation value calculation process for each combination of the first movable body and the second movable body. The first evaluation value calculation process includes a process of (i) determining over time whether the degree of coincidence of the positions is higher than a predetermined value and (ii) each time determining that the degree of coincidence of the positions is higher than the predetermined value, increasing the evaluation value by a predetermined value, or each time determining that the degree of coincidence of the positions is equal to or lower than the predetermined value, reducing the evaluation value by a predetermined value. The recognition processing module 240 performs the recognition process by recognizing, as a single movable body, the combination of the movable bodies having an evaluation value which has reached a predetermined value.

The recognition processing module 240 may perform a second evaluation value calculation process for each combination of the first movable body and the second movable body. The second evaluation value calculation process includes a process of determining over time whether a degree of coincidence of positions is higher than a predetermined value and a degree of coincidence of moving directions is higher than a predetermined value, and increasing an evaluation value by a predetermined value each determining that the degree of coincidence of positions is higher than a predetermined value and a degree of coincidence of moving directions is higher than a predetermined value, or reducing an evaluation value by a predetermined value each time determining that a degree of coincidence of positions is equal to or lower than a predetermined value or a degree of coincidence of moving directions is equal to or lower than a predetermined value. The recognition processing module 240 performs the recognition process by recognizing, as a single movable body, the combination of the movable bodies having an evaluation value which has reached a predetermined value.

If it is determined that there are movable bodies which will approach each other within a predetermined time based on position information of movable bodies obtained by applying the recognition process to the position information of the first movable body and the position information of the second movable bodies, the assistance control module 260 performs control for transmitting an alarm to at least one movable body among movable bodies which will possibly approach each other.

Based on the history of position information of movable bodies obtained by applying the recognition process to the position information of the first movable body and the position information of the second movable bodies, the assistance control module 260 may predict a position of a movable body which went from within a capturing range of the capturing device 70 to outside of the capturing range; and determine whether there are movable bodies which will approach each other within a predetermined time based on the position of the movable body which is predicted and a position indicated by position information of another movable body. As a result, it is possible to continue assistance for a movable body which has gone out of the capturing range of the capturing device 70 for a certain period of time.

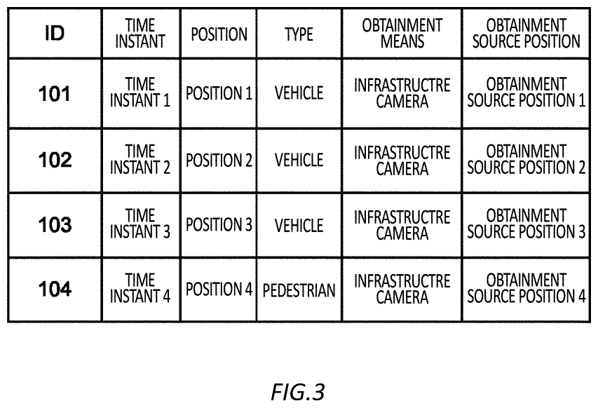

FIG. 3 shows, in a tabulated form, the first reception information which the assistance device 60 received from the capturing device 70. The first reception information includes IDs, time instants, positions, types, obtainment means, and obtainment source positions as the data items.

The ID indicates the identification information of the movable body. The capturing device 70 assigns the identification information to the movable body obtained by analyzing the image. The position information transmitted from the capturing device 70 includes the identification information which the capturing device 70 assigned to the movable body.

The time instant indicates the time instant at which the position is obtained in the capturing device. The position indicates the position of the movable body. Specifically, the position indicates the position of the movable body which the capturing device 70 obtains by analyzing the image. The position may be latitude and longitude information, for example.

The type indicates the type of the movable body. The capturing device 70 identifies the type of the movable body obtained by analyzing the image. The position information transmitted from the capturing device 70 includes the type of the movable body which the capturing device 70 identifies.

The obtainment means are information indicating the obtainment means of the position information. The “infrastructure camera” in FIG. 3 indicates that the obtainment means of the position information is the capturing device 70 installed on the road infrastructure.

The obtainment source position indicates the position information of the position where the capturing device 70 as the obtainment means is installed. The obtainment source position may be latitude and longitude information.

The ID “101”, “102”, and “103” in FIG. 3 refer to the identification information of the vehicle 20a, the vehicle 20c, and the vehicle 20d, respectively, given by the capturing device 70. The ID “104” refers to the identification information of the user 80f given by the capturing device 70.

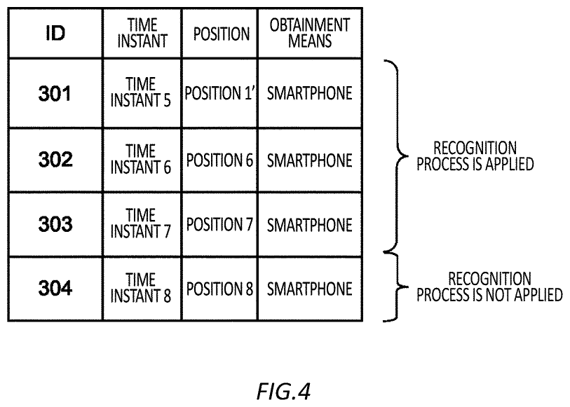

FIG. 4 shows, in a tabulated form, the second reception information which the assistance device 60 receives from the user terminal 82. The second reception information includes the IDs, the time instants, the positions, and the obtainment means as the data items.

The ID indicates the identification information of the movable body. The position information transmitted from the user terminal 82 includes the identification information fixedly assigned to the user terminal 82.

The time instants indicate the time instant at which the position information is obtained in the user terminal 82. The position indicates the position of the movable body. Specifically, the position indicates the position of the vehicle 20 detected by the user terminal 82. The position may be latitude and longitude information, for example.

The obtainment means are the obtainment means of the position information. The “smartphone” in FIG. 4 indicates that the obtainment means of the position information is a smartphone.

The IDs “301”, “302”, “303”, and “304” in FIG. 4 refer to the identification information of the user terminal 82a, the user terminal 82b, the user terminal 82e, and the user terminal 82g, respectively.

As described with reference to FIG. 1, the recognition processing module 240 applies the recognition process to only the movable body which exists within the range 100 and whose position information has been detected. In other words, in the examples of FIG. 3 and FIG. 4, the recognition processing module 240 applies the recognition process to only the combination of four positions each corresponding to the ID “101”, the ID “102”, the ID “103”, and the ID “104” in FIG. 3 and three positions each corresponding to the ID “301”, the ID “302”, and the ID “303” in FIG. 4. In other words, the recognition process is not to be applied to the position of the ID “304” in FIG. 4. As a result, the calculation amount for the recognition process can be reduced.

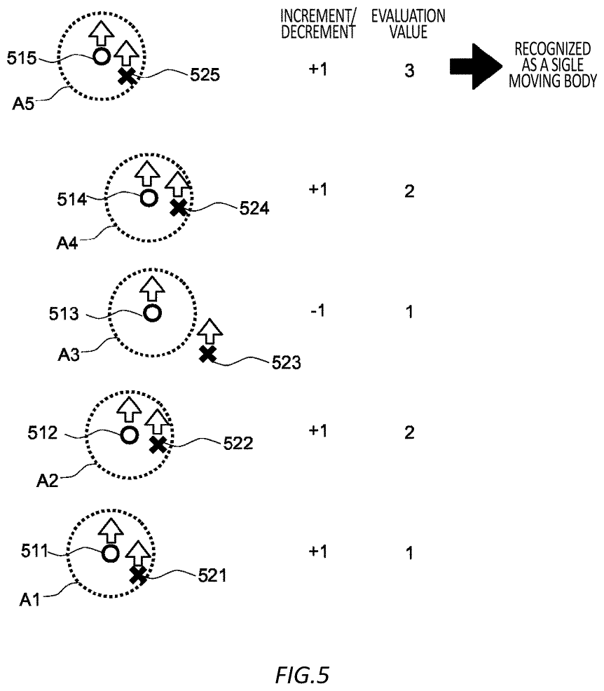

FIG. 5 is a diagram for describing the recognition process in the recognition processing module 240. FIG. 5 shows the case in which it is determined that the first movable body and the second movable body are recognized as a single movable body.

FIG. 5 shows a case where the comparison between the position of the first movable body and the positions of the second movable bodies is performed five times at a predetermined time interval. In FIG. 5, the position 511, the position 512, the position 513, the position 514, and the position 515 indicate the positions of the first movable body. The position 521, the position 522, the position 523, the position 524, and the position 525 indicate the positions of the second movable bodies. FIG. 5 shows the moving direction identified from the history of a plurality of pieces of position information for each of the first movable body and the second movable bodies. Here, the moving direction indicates whether a movable body is facing the positive direction or facing the negative direction, the positive direction being the moving direction of each movable body.

The initial value of the evaluation value for recognizing the first movable body and the second movable body as a single movable body is 0. At the first time instant, the position of the first movable body is the position 511 and the position of the second movable body is the position 521. The recognition processing module 240 determines whether the position 521 of the second movable body exists within the predetermined range A1 from the position 511 as the center and the moving directions are the same. The position 521 exists within the range A1 and also the moving directions are the same. Therefore, 1 is added to the evaluation value. As a result, the evaluation value is 1.

A similar process is also performed at the second time instant to the fifth time instant. In other words, since, at the second time instant, the position 522 of the second movable body exists within the predetermined range A2 from the position 512 of the first movable body as the center and the moving directions are the same, the recognition processing module 240 adds 1 to the evaluation value. As a result, the evaluation value is 2 at the second time instant.

At the third time instant, the position 523 of the second movable body does not exist within the predetermined range A3 from the position 513 of the first movable body as the center. Therefore, the recognition processing module 240 subtracts 1 from the evaluation value. As a result, the evaluation value is 1 at the third time instant.

Since, at the fourth time instant, the position 524 of the second movable body exists within the predetermined range A4 from the position 514 of the first movable body as the center and also the moving directions are the same, the recognition processing module 240 adds 1 to the evaluation value. As a result, at the fourth time instant, the evaluation value is 2. Since, at the fifth time instant, the position 525 of the second movable body exists within the predetermined range A5 from the position 515 of the first movable body as the center and also the moving directions are the same, the recognition processing module 240 adds 1 to the evaluation value. As a result, at the fifth time instant, the evaluation value is 3.

At the moment when the evaluation value becomes equal to or more than the first threshold, which is 3, the recognition processing module 240 determines that the first movable body and the second movable body are to be recognized as a single movable body.

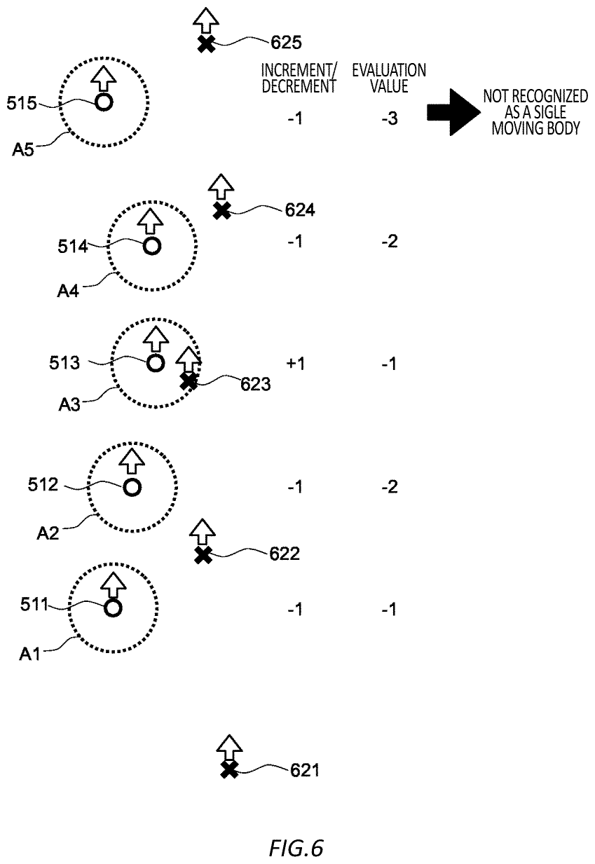

FIG. 6 is another diagram for describing the recognition process in the recognition processing module 240. FIG. 6 shows a case where it is determined that the first movable body and the second movable body are not to be recognized as a single movable body.

As with FIG. 5, FIG. 6 shows the case where the comparison between the position of the first movable body and the position of the second movable body is performed five times at a predetermined time interval. At a first time instant, the position of the first movable body is the position 511, and the position of the second movable body is not within the range A1. Therefore, the recognition processing module 240 subtracts one from the evaluation value. As a result, at the first time instant, the evaluation value is −1.

Similarly, since at the second time instant, the position 622 of the second movable body does not exist within the range A2 from the position 512 of the first movable body as the center, the recognition processing module 240 subtracts 1 from the evaluation value. As a result, at the second time instant, the evaluation value is −2.

At the third time instant, the position 623 of the second movable body exists within the range A3 from the position 513 of the first movable body as the center and the moving directions are the same. Therefore, the recognition processing module 240 adds one to the evaluation value. As a result, at the third time instant, the evaluation value is −1.

Since, at the fourth time instant, the position 624 of the second movable body does not exist within the range A4 from the position 514 of the first movable body as the center, the recognition processing module 240 subtracts 1 from the evaluation value. As a result, at the fourth time instant, the evaluation value is −2. Since, at the fifth time instant, the position 625 of the second movable body does not exist within the range A5 from the position 515 of the first movable body as the center, the recognition processing module 240 subtracts 1 from the evaluation value. As a result, at the fifth time instant, the evaluation value is −3.

At the moment when the evaluation value becomes equal to or less than the second threshold, which is −3, the recognition processing module 240 determines that the first movable body and the second movable body are to be recognized as a single movable body.

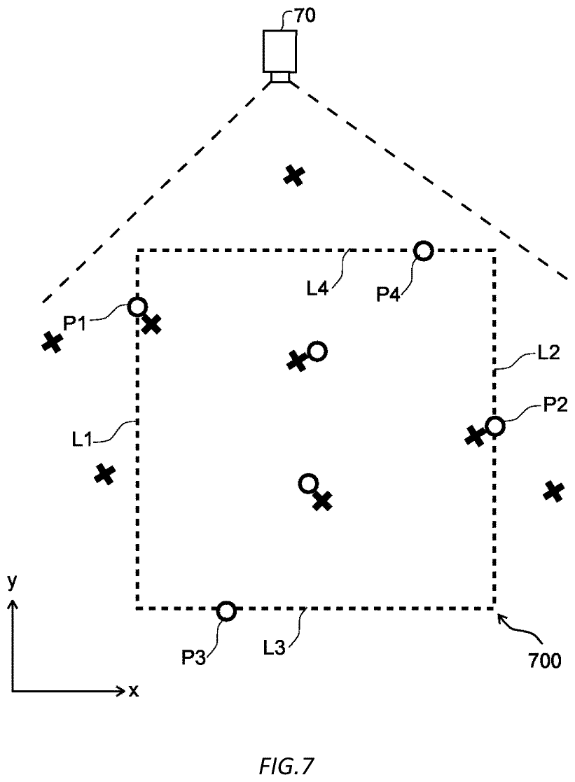

FIG. 7 schematically shows another example of the range to which the recognition process is to be applied. In FIG. 7, circle-shaped symbols indicate the positions of the first movable body detected by the capturing device 70 and x-shaped symbols indicate the positions of the second movable bodies detected by the user terminal 82, in the x-y coordinate system.

The range setting module 230 identifies, among positions of the first movable body detected by the capturing device 70, P1 with the lowest x coordinate value; P2 with the highest x coordinate value; P3 with the lowest y coordinate value; and P4 with the highest y coordinate value. The range setting module 230 determines the range 700 which is defined by the line L1 passing P1 and parallel to the y-axis; the line L2 passing P2 and parallel to the y-axis; the line L3 passing P3 and parallel to the x-axis; and the line L4 passing P4 and parallel to the x-axis to be the range to which the recognition process is to be applied.

Whether the coordinate of the second movable body is included within the range 700 can be determined by determining whether the x coordinate of the position of the second movable body is between the x coordinate of P1 and the x coordinate of P2 and the y coordinate of the position of the second movable body is between the y coordinate of P3 and the y coordinate of P4. Since the determination can be made based on the magnitude relationship among coordinate values in this manner, the calculation amount of the process to extract the coordinate of the second movable body included in the range 700 can be reduced. Furthermore, the recognition process can be applied to the second movable body whose position has been detected near the first movable body whose position has been actually obtained by the capturing device 70. As a result, it can be expected that the calculation amount of the recognition process is further reduced.

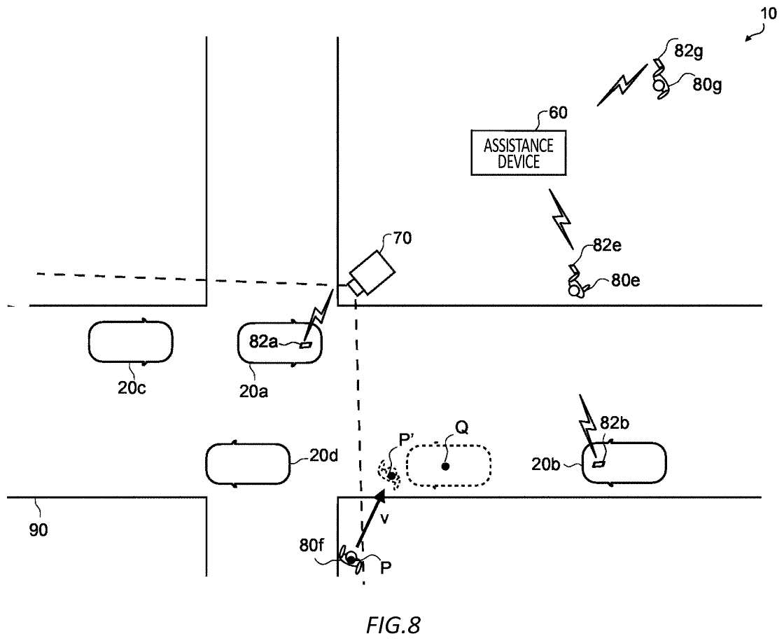

FIG. 8 is a diagram for describing the assistance method in the case where the user 80f has gone out of the capturing range of the capturing device 70.

The assistance control module 260 has the position P and the moving speed v immediately before the user 80f goes out of the capturing range. The assistance control module 260 estimates the position of the user 80f based on the position P and the moving speed v for a predetermined time from the moment when the user 80f goes out of the capturing range. For example, the assistance control module 260 can estimate the position P′ after T seconds based on the position P and the moving speed v.

The assistance control module 260 estimates the position Q of the vehicle 20b after T seconds based on the history of the position information of the user terminal 82b. When determining that the distance between the position P′ and Q is less than a predetermined value, the assistance control module 260 determines to perform the assistance for the user 80f and/or the vehicle 20b. For example, the assistance control module 260 performs the assistance by instructing the user terminal 82b to output an alarm. In this case, the assistance control module 260 may weaken the intensity of the alarm. For example, if the user 80f is located within the capturing range of the capturing device 70, an alarm stating that “there is a pedestrian in the proximity” is output, whereas if the user 80f has gone out of the capturing range of the capturing device 70, an alarm stating that “there is possibly a pedestrian in the proximity” is output. As a result, the assistance can be performed in consideration of the possibility of a lower assistance precision.

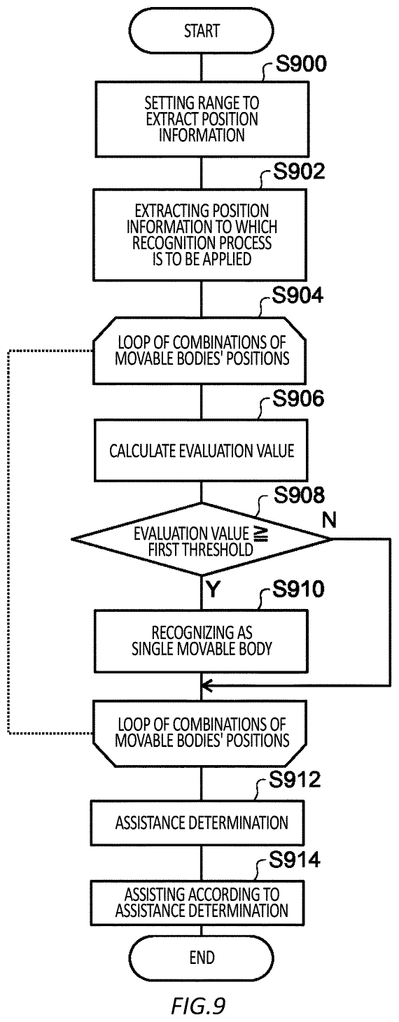

FIG. 9 shows an example of a flowchart related to the assistance control method performed by the assistance device 60.

In S900, the range setting module 230 sets the range to extract the position information to which the recognition process is to be applied. The range setting module 230 may set the range based on the position of the capturing device 70 as in the case of the range 100 described with reference to FIG. 1. The installation position of the capturing device 70 is included in the position information transmitted from the capturing device 70. The range setting module 230 may set the range based on the position detected by the capturing device 70 as in the case of the range 700 described with reference to FIG. 7.

In S902, the recognition processing module 240 extracts, within the range set in S900, the position information of the second movable bodies to which the recognition process is to be applied.

In S904, the recognition processing module 240 performs the loop processing by repeating the processes from S906 to S910 for the combination of the position of the first movable body and the position of the second movable body extracted in S902.

In S906, the recognition processing module 240 calculates the evaluation value. For example, the recognition processing module 240 calculates the evaluation value using the method described with reference to FIG. 5 and FIG. 6. Although a case in which the calculation of the evaluation value ends after five calculation steps has been described with reference to FIG. 5 and FIG. 6, an upper limit value may be set for the number of calculation steps for calculating the evaluation value. The recognition processing module 240 may end the calculation of the evaluation value when the number of calculation steps of the evaluation value reaches the upper limit value.

In S908, it is determined whether the evaluation value calculated in S906 is equal to or more than the first threshold. If it is determined that the evaluation value is equal to or more than the first threshold, the process of S910 is performed. If it is determined that the evaluation value is less than the first threshold, the loop processing proceeds to the next step. In S910, the recognition processing module 240 determines that the first movable body and the second movable body are to be recognized as a single movable body.

In S912, the assistance control module 260 performs an assistance determination of whether to perform an assistance. For example, for each of a plurality of movable bodies to which the recognition process has been applied by the recognition processing module 240, the assistance control module 260 predicts the future positions of the movable bodies, and, if predicting that the movable bodies will approach another movable body within a predetermined time, it determines to perform assistance for the movable bodies and/or the other movable body. The assistance control module 260 may determine whether the movable bodies will approach another movable body depending on whether the predicted distance between the movable bodies after a predetermined time is smaller than a predetermined value.

When the assistance determination is performed by recognizing the first movable body and the second movable body as a single movable body and both of the position detected by the capturing device 70 and the position detected by the user terminal 82 has been detected, any one of the position may be used for the assistance determination and the average value of the position detected in the capturing device 70 and the position detected in the user terminal 82 may be used for the assistance determination.

In S914, the assistance control module 260 performs the assistance for the movable body according to the assistance determination in S912. For example, the assistance control module 260 controls the communication device 290 to transmit alarm information, which instructs to output an alarm, to at least one of the movable body predicted to approach another movable body in the determination in S912 or the other movable body. For example, in the example of FIG. 1, when the assistance control module 260 applies the assistance for the user terminal 82e, it transmits to the user terminal 82e the alarm information which instructs the user terminal 82e to output the alarm information through voice and/or screen display or the like. When receiving the alarm information, the user terminal 82e informs, through the Human Machine Interface (HMI) function which the user terminal 82e has, the user 80e that there is a vehicle approaching the user 80e.

According to the assistance system 10 described above, the position information to which the recognition process is to be applied for determining whether movable bodies are to be recognized as a single movable body can be limited to a particular range. As a result, the processing load of the recognition process can be reduced. Thus, a significant delay in transmitting the alarm information can be prevented.

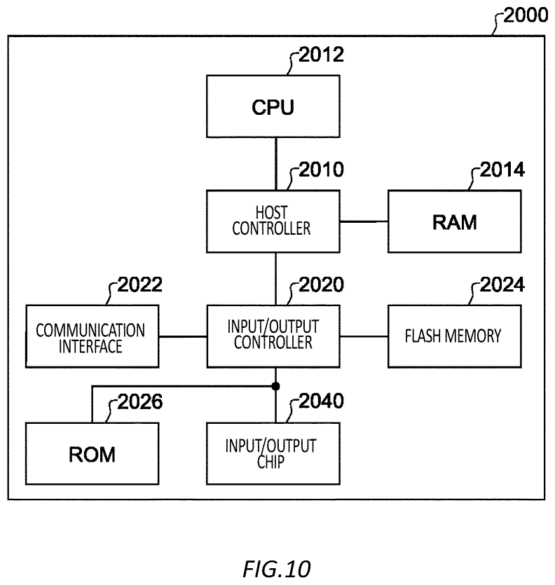

FIG. 10 shows an example of a computer 2000 in which a plurality of embodiments of the present invention may be entirely or partially embodied. The program installed on the computer 2000 can cause the computer 2000 to function as a device such as the assistance device 60 according to the embodiments or each module of the device, to perform the operations associated with the device or each module of the the device, and/or to perform a process according to the embodiments or a step of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each module.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An device or a method may be actualized by executing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information search/replacement, or the like described herein and specified by instruction sequences of the programs, and write back a result into the RAM 2014. In addition, the CPU 2012 may search for information in a file, a database, or the like in the recording medium. For example, when multiple entries each having an attribute value of a first attribute associated with an attribute value of a second attribute, is stored in the recording medium, the CPU 2012 may search for an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The program which is installed on the computer 2000 and causes the computer 2000 to function as the assistance device 60 may instruct the CPU 2012 or the like to cause the computer 2000 to function as each module of the assistance device 60 (for example, the assistance control device 200 or the like). The information processing described in these programs is read by the computer 2000 to function as each module of the assistance device 60, which is the specific means in which the software and various types of hardware resources described above cooperate. These specific means implement operations or processing of information according to the intended use of the computer 2000 in the present embodiment, and the assistance device 60 is thereby constructed to be specific for the intended use.

Various embodiments have been described with reference to the block diagrams or the like. In the block diagrams, each block may represent (1) a stage of a process in which an operation is executed, or (2) each module of the device having a role in executing the operation. A particular step and each module may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, or the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, or the like.

While the present invention has been described above by using the embodiments, the technical scope of the present invention is not limited to the scope of the above-described embodiments. It is apparent to persons skilled in the art that various alterations or improvements can be made to the above described embodiments. It is also apparent from description of the claims that the embodiments to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: assistance system;
20: vehicle;
60: assistance device;
70: capturing device;
80: user;
82: user terminal;
90: road;
100: range;
200: assistance control device;
202: obtainment module;
210: first obtainment module;
220: second obtainment module;
230: range setting module;
240: recognition processing module;
260: assistance control module;
280: storage device;
290: communication device;
700: range;
2000: computer;
2010: host controller;
2012: CPU;
2014: RAM;
2020: input/output controller;
2022: communication interface;
2024: flash memory;
2026: ROM;
2040: input/output chip.

What is claimed is:

1. An assistance control device comprising:
a first obtainment module which obtains position information of a first movable body detected from an image captured by a capturing device;
a second obtainment module which obtains position information of second movable bodies measured at each of the second movable bodies;
a recognition processing module which performs a recognition process by comparing the position information of the first movable body to the position information of the second movable bodies for each combination of the first movable body and the second movable bodies and recognizing, as a single movable body, a combination of movable bodies having a degree of coincidence of position information which is higher than a predetermined value; and
an assistance control module which performs control for traffic assistance for a movable body based on position information of a movable body obtained by applying the recognition process to the position information of the first movable body and the position information of the second movable bodies;
wherein the recognition processing module limits position information, among the position information of the first movable body and the position information of the second movable bodies, to which the recognition process is to be applied, to position information within a predetermined range which is set based on a position of the capturing device as a reference.

2. The assistance control device according to claim 1, wherein the predetermined range is a predetermined and fixed range including a position where the capturing device is installed.

3. The assistance control device according to claim 1, further including a range setting module which selects, among the position information of the first movable body obtained by the first obtainment module, at least four pieces of position information having outermost coordinate components for each of two coordinate axes set within the predetermined range and sets, as the predetermined range, a range defined by lines passing each of the position information which has been selected.

4. The assistance control device according to claim 1, wherein the recognition processing module compares a position indicated by the position information of the first movable body to a position indicated by the position information of the second movable bodies for each combination of the first movable body and the second movable bodies and recognizes, as a single movable body, a combination of movable bodies having a degree of coincidence of positions which is higher than a predetermined value.

5. The assistance control device according to claim 4, wherein the recognition processing module recognizes, as a single movable body, a combination of movable bodies having the degree of coincidence of positions which is higher than a predetermined value for a predetermined time.

6. The assistance control device according to claim 4, wherein the recognition processing module further compares a moving direction identified from a history of the position information of the first movable body to a moving direction identified from a history of the position information of the second movable bodies for each combination of the first movable body and the second movable bodies and recognizes, as a single movable body, a combination of movable bodies having a degree of coincidence of positions which is higher than a predetermined value and a degree of coincidence of moving directions which is higher than a predetermined value.

7. The assistance control device according to claim 6, wherein the recognition processing module recognizes, as a single movable body, a combination of movable bodies having a degree of coincidence of positions which is higher than a predetermined value for a predetermined time and a degree of coincidence of moving directions which is higher than a predetermined value for a predetermined time.

8. The assistance control device according to claim 4, wherein, for each combination of the first movable body and the second movable bodies, the recognition processing module performs a process of:
determining over time whether the degree of coincidence of positions is higher than a predetermined value; and
increasing an evaluation value by a predetermined value each time the degree of coincidence of positions is determined to be higher than a predetermined value, and reducing the evaluation value by a predetermined value each time the degree of coincidence of positions is determined to be equal to or lower than a predetermined value, and
the recognition processing module performs a recognition process of recognizing, as a single movable body, a combination of movable bodies for which the evaluation value has reached a predetermined value.

9. The assistance control device according to claim 6, wherein, for each combination of the first movable body and the second movable bodies, the recognition processing module performs a process of:
determining over time whether the degree of coincidence of positions is higher than a predetermined value and the degree of coincidence of moving directions is higher than a predetermined value; and
increasing an evaluation value by a predetermined value each time the degree of coincidence of positions is determined to be higher than a predetermined value and the degree of coincidence of moving directions is higher than a predetermined value and reducing the evaluation value by a predetermined value each time the degree of coincidence of positions is determined to be equal to or lower than a predetermined value or the degree of coincidence of moving directions is determined to be equal to or lower than a predetermined value, and
the recognition processing module performs a recognition process by recognizing, as a single movable body, a combination of movable bodies for which the evaluation value has reached a predetermined value.

10. The assistance control device according to claim 1, wherein the assistance control module performs control for transmitting an alarm to at least one movable body among movable bodies which will possibly approach each other if it is determined that there are the movable bodies which will approach each other within a predetermined time based on position information of the movable bodies obtained by applying the recognition process to the position information of the first movable body and the position information of the second movable bodies.

11. The assistance control device according to claim 10, wherein, based on a history of position information of the movable bodies obtained by applying the recognition process to the position information of the first movable body and the position information of the second movable bodies, the assistance control module:
predicts a position of the movable bodies that have gone out from within a capturing range of the capturing device to outside of the capturing range; and
determines whether there are the movable bodies which will approach each other within a predetermined time based on the position of the movable body which is predicted and a position indicated by position information of another movable body.

12. The assistance control device according to claim 2, wherein the recognition processing module compares a position indicated by the position information of the first movable body to a position indicated by the position information of the second movable bodies for each combination of the first movable body and the second movable bodies and recognizes, as a single movable body, a combination of the movable bodies having a degree of coincidence of positions which is higher than a predetermined value.

13. The assistance control device according to claim 3, wherein the recognition processing module compares a position indicated by the position information of the first movable body to a position indicated by the position information of the second movable bodies for each combination of the first movable body and the second movable bodies and recognizes, as a single movable body, a combination of the movable bodies having a degree of coincidence of positions which is higher than a predetermined value.

14. The assistance control device according to claim 12, wherein the recognition processing module recognizes, as a single movable body, a combination of the movable bodies having the degree of coincidence of positions which is higher than a predetermined value for a predetermined time.

15. The assistance control device according to claim 13, wherein the recognition processing module recognizes, as a single movable body, a combination of the movable bodies having the degree of coincidence of positions which is higher than a predetermined value for a predetermined time.

16. The assistance control device according to claim 12, wherein the recognition processing module further compares a moving direction identified from a history of the position information of the first movable body to a moving direction identified from a history of the position information of the second movable bodies for each combination of the first movable body and the second movable bodies and recognizes, as a single movable body, a combination of the movable bodies having a degree of coincidence of positions which is higher than a predetermined value and a degree of coincidence of moving directions which is higher than a predetermined value.

17. The assistance control device according to claim 13, wherein the recognition processing module further compares a moving direction identified from a history of the position information of the first movable body to a moving direction identified from a history of the position information of the second movable bodies for each combination of the first movable body and the second movable bodies and recognizes, as a single movable body, a combination of the movable bodies having a degree of coincidence of positions which is higher than a predetermined value and a degree of coincidence of moving directions which is higher than a predetermined value.

18. The assistance control device according to claim 16, wherein the recognition processing module recognizes, as a single movable body, a combination of the movable bodies having a degree of coincidence of positions which is higher than a predetermined value for a predetermined time and a degree of coincidence of moving directions which is higher than a predetermined value for a predetermined time.

19. An assistance control method comprising:
obtaining position information of a first movable body detected from an image captured by a capturing device;
obtaining position information of second movable bodies measured at each of the second movable bodies;
performing a recognition process by comparing the position information of the first movable body to the position information of the second movable bodies for each combination of the first movable body and the second movable bodies and recognizing, as a single movable body, a combination of the movable bodies having a degree of coincidence of position information which is higher than a predetermined value; and
performing control for traffic assistance for the movable bodies based on position information of the movable bodies obtained by applying the recognition process to the position information of the first movable body and the position information of the second movable bodies;
wherein the performing of the recognition process limits position information, among the position information of the first movable body and the position information of the second movable bodies, to which the recognition process is to be applied, to position information within a predetermined range which is set based on a position of the capturing device as a reference.

20. A non-transitory computer-readable storage medium which stores a program thereon, wherein the program causes a computer to function as:
a first obtainment module which obtains position information of a first movable body detected from an image captured by a capturing device;
a second obtainment module which obtains position information of second movable bodies measured at each of the second movable bodies;
a recognition processing module which performs a recognition process by comparing the position information of the first movable body to the position information of the second movable bodies for each combination of the first movable body and the second movable bodies and recognizing, as a single movable body, a combination of the movable bodies having a degree of coincidence of position information which is higher than a predetermined value; and
an assistance control module which performs control for traffic assistance for the movable bodies based on position information of a movable body obtained by applying the recognition process to the position information of the first movable body and the position information of the second movable bodies;
wherein the recognition processing module limits position information, among the position information of the first movable body and the position information of the second movable bodies, to which the recognition process is to be applied, to position information within a predetermined range which is set based on a position of the capturing device as a reference.
